(19) United States
(12) Patent Application Publication
(10) Pub. No.: US 2024/0310280 A1
(43) Pub. Date: Sep. 19, 2024

(54) SURFACE PLASMON RESONANCE SENSOR AND METHOD OF SENSING INFINITESIMAL ORGANIC IMPURITIES IN SEMICONDUCTOR CHEMICALS USING THE SAME

(71) Applicant: Samsung Electronics Co., Ltd., Suwon-si (KR)

(72) Inventors: Wontaek Kim, Suwon-si (KR); Howon Jang, Suwon-si (KR); Sunghwan Cho, Suwon-si (KR); Soyoung Kim, Suwon-si (KR); Minsoo Suh, Suwon-si (KR); Jaeyeon Chung, Suwon-si (KR)

(73) Assignees: Samsung Electronics Co., Ltd., Suwon-si (KR); Seoul National University R&DB Foundation, Seoul (KR)

(21) Appl. No.: 18/594,079

(22) Filed: Mar. 4, 2024

(30) Foreign Application Priority Data
Mar. 14, 2023 (KR) 10-2023-0033477
Jul. 6, 2023 (KR) 10-2023-0087991

(51) Int. Cl. G01N 21/552; C01B 32/182; G01N 21/85

(52) U.S. Cl. CPC G01N 21/553; C01B 32/182; G01N 21/85; C01B 2204/02; C01B 2204/22

(57) ABSTRACT

Provided is a method of sensing organic impurities by using an SPR sensor, the method including bringing a target fluid into contact with the SPR sensor, and sensing the presence of organic impurities in the target fluid using adsorption and desorption of organic impurities to and from the SPR sensor.

### CROSS-REFERENCE TO RELATED APPLICATION

This application is based on and claims priority under 35 U.S.C. § 119 to Korean Patent Application Nos. 10-2023-0033477, filed on Mar. 14, 2023, and 10-2023-0087991, filed on Jul. 6, 2023, in the Korean Intellectual Property Office, the disclosures of which are incorporated by reference herein in their entireties.

### BACKGROUND

The inventive concept relates to a surface plasmon resonance sensor and a method of sensing infinitesimal organic impurities in semiconductor chemicals using the same. More specifically, the inventive concept relates to a plasmon resonance sensor capable of checking whether organic impurities exist in a target fluid by coming in direct contact with the target fluid, and a method of detecting infinitesimal organic impurities using the same.

Process fluids, such as chemicals used in semiconductor manufacturing, are generally stored in source tanks and are used in processes after pretreatment and transportation. However, impurities may exist in the source tanks or added to the process fluids during transportation.

When impurities are present in the process fluids, the presence of impurities is recognized in the final stage, which causes enormous damage to the manufacturing yield and process cost. In particular, in the case of semiconductor chemicals used in semiconductor manufacturing, when devices have small feature sizes and the processes are complicated, even very minute quantities of a contaminant may cause a fatal decrease in yield. In the case of an offline sampling method in which part of the process fluid is extracted and it is checked whether the extracted process fluid contains impurities, the method not only is time consuming, but also a process is stopped while performing the method. As a result, the offline sampling method would be greatly improved by a system and method to measure impurities in real time in a process fluid which flows and is used in the actual process.

### SUMMARY

The inventive concept provides a Surface Plasmon Resonance (SPR) sensor for sensing organic impurities, which has reliable sensing capabilities, even when a target fluid contains very low concentrations of organic impurities and is capable of checking the presence of organic impurities in real time without separate cleaning.

The inventive concept provides a method of sensing organic impurities using an SPR sensor that has reliable sensing capabilities even when a target fluid contains very low concentrations of organic impurities, and is capable of checking the presence of organic impurities in real time without separate cleaning.

According to an aspect of the inventive concept, there is provided a method of sensing infinitesimal organic impurities in a semiconductor chemical by using an SPR sensor. The method of sensing organic impurities includes bringing a target fluid into contact with the SPR sensor, and sensing the presence of the organic impurities in the target fluid using adsorption and desorption of organic impurities to and from the SPR sensor.

According to another aspect of the inventive concept, there is provided a method of sensing infinitesimal organic impurities in a semiconductor chemical using an SPR sensor. The method for sensing organic impurities incudes the steps of: bringing a target fluid into contact with a first SPR sensor connected to a pipe connecting a storage tank, a buffer tank, and a waste tank with each other, sensing, in real time, whether the organic impurities are present in the target fluid by using adsorption and desorption of organic impurities to and from the first SPR sensor, and transporting the target fluid to the buffer tank or the waste tank by adjusting a switching valve connected to the pipe at a rear end of the first SPR sensor.

According to another aspect of the inventive concept, there is provided a method of sensing infinitesimal organic impurities in a semiconductor chemical using an SPR sensor. The method of sensing organic impurities includes transporting a first target fluid from a first storage tank to a buffer tank, sensing the presence of organic impurities in the first target fluid by using the adsorption and desorption of organic impurities to and from the first SPR sensor, transporting the first target fluid to a waste tank by adjusting a first switching valve at a rear end of the first SPR sensor, transporting a second target fluid from a second storage tank to the buffer tank, and sensing whether the organic impurities are present in the second target fluid by using the adsorption and desorption of the organic impurities to and from the second SPR sensor.

According to another aspect of the inventive concept, there is provided a surface plasmon resonance (SPR) sensor for sensing infinitesimal organic impurities in a semiconductor chemical. The SPR sensor includes a prism, a sensor chip on the prism, a light source configured to irradiate light to the sensor chip through the prism, and a detector configured to receive the light reflected from the sensor chip through the prism, wherein the sensor chip includes a metal layer configured to induce a SPR phenomenon, and a carbon-containing layer arranged on the metal layer and configured to be in direct contact with a target fluid to sense whether organic impurities are present in the target fluid.

### BRIEF DESCRIPTION OF THE DRAWINGS

Embodiments of the inventive concept will be more clearly understood from the following detailed description taken in conjunction with the accompanying drawings in which:

FIG. 1A is a plan view illustrating a surface plasmon resonance (SPR) sensor according to embodiments;

FIGS. 1B and 1C are cross-sectional views taken along line A-A′ of FIG. 1A, respectively showing an SPR sensor of a first case without organic impurities in a target fluid and an SPR sensor of a second case including organic impurities in a target fluid;

FIG. 2 is a graph illustrating an SPR reflectance curve for showing an organic impurity sensing principle of an SPR sensor according to embodiments;

FIG. 3 is a plan view illustrating a surface plasmon resonance (SPR) sensor according to some embodiments;

FIG. 4 is a flowchart illustrating a method of sensing organic impurities using an SPR sensor according to embodiments;

FIG. 5A, FIG. 5B, FIG. 5C, and FIG. 5D are graphs respectively showing SPR response curves according to embodiments;

FIG. 6 is a graph illustrating an SPR response curve according to the type of organic impurities of an SPR sensor according to some embodiments;

FIG. 7 is a graph illustrating an SPR response curve according to the concentration of organic impurities of an SPR sensor according to some embodiments;

FIG. 8 is a graph showing an SPR response curve over time when a target fluid of a first case and a target fluid of a second case are alternately introduced into an SPR sensor according to some embodiments;

FIG. 9A and FIG. 9B are graphs showing SPR reflectance curves according to an Example and a Comparative Example, respectively;

FIG. 10A and FIG. 10B are graphs respectively showing an electric field and SPR reflectance of a recognition layer according to the thickness of a metal layer;

FIG. 11 is a graph illustrating an SPR response curve according to the type of organic impurities of an SPR sensor according to some embodiments;

FIG. 12 is a graph illustrating an SPR response curve according to the type of organic impurities of an SPR sensor according to some other embodiments;

FIG. 13 is a block diagram illustrating an organic impurity sensing system using an SPR sensor according to embodiments;

FIG. 14 is a flowchart illustrating a method of sensing organic impurities by using an organic impurity sensing system including an SPR sensor according to embodiments;

FIG. 15 is a block diagram illustrating an organic impurity sensing system using an SPR sensor according to some embodiments;

FIG. 16 is a block diagram illustrating an organic impurity sensing system including an SPR sensor according to some other embodiments; and

FIG. 17 is a flowchart illustrating a method of sensing organic impurities using an organic impurity sensing system including an SPR sensor according to some embodiments.

### DETAILED DESCRIPTION OF THE EMBODIMENTS

Hereinafter, embodiments of the inventive concept will be described in detail with reference to the accompanying drawings. The same reference numerals are used for the same components in the drawings, and redundant descriptions thereof will be omitted.

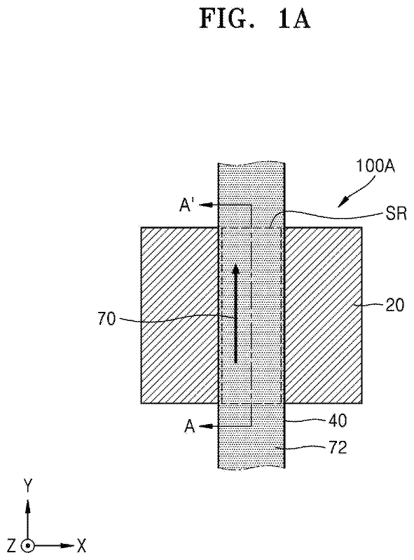

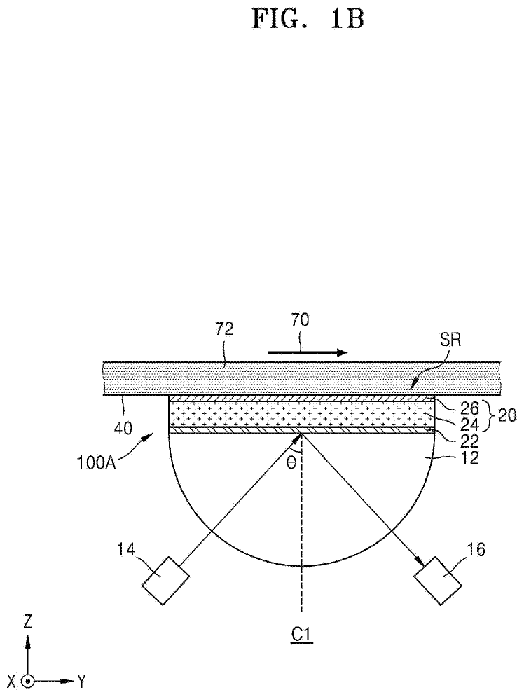

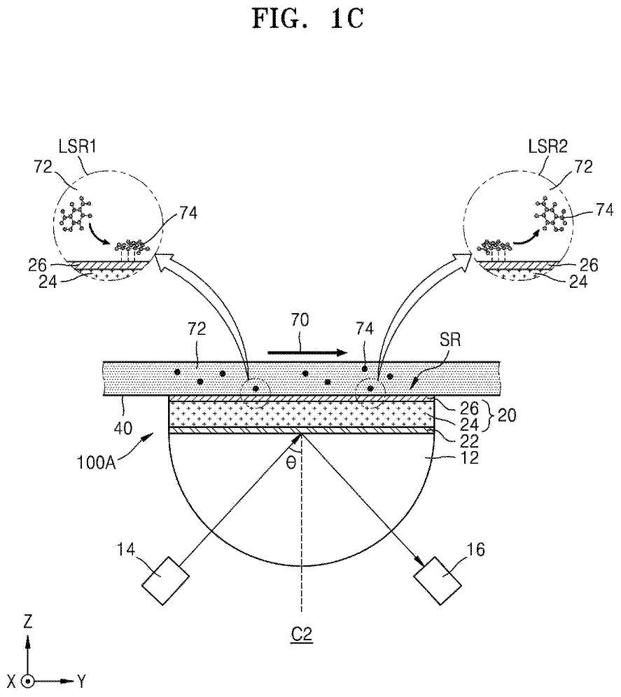

FIG. 1A is a plan view illustrating a surface plasmon resonance (SPR) sensor 100A according to embodiments. FIGS. 1B and 1C are cross-sectional views taken along line A-A′ of FIG. 1A for describing the SPR sensor 100A. Specifically, FIG. 1B shows an SPR sensor 100A of a first case C1 in which organic impurities 74 are not included in a target fluid 72, and FIG. 1C shows a SPR sensor 100A of a second case C2 including organic impurities 74 in a target fluid 72.

Referring to FIGS. 1A to 1C, the SPR sensor 100A may include a prism 12, a sensor chip 20, a channel 40, a light source 14, and a detector 16. According to embodiments, the sensor chip 20 may include a metal layer 24 and a recognition layer 26 on the metal layer 24.

According to embodiments, the sensor chip 20 may be arranged on the prism 12, and the channel 40 may be arranged on the sensor chip 20. The target fluid 72 may flow in the channel 40 in a horizontal direction as indicated by an arrow 70 in FIGS. 1A to 1C. The target fluid 72 may not include the organic impurities 74 as illustrated in FIG. 1B, or may include the organic impurities 74 as illustrated in FIG. 1C.

The light source 14 may be configured to irradiate light onto the bottom of the sensor chip 20 through the prism 12 under the sensor chip 20, and the detector 16 may be configured to receive light reflected from the sensor chip 20 through the prism 12. The SPR sensor 100A may measure an SPR reflectance curve, which represents the intensity of light (e.g., reflectance) over a range of incidence angles of light received through the detector 16. The SPR sensor 100A may measure a difference between the reflectance of a reference fluid to be compared and the reflectance measured from the target fluid 72. In this specification, the reference fluid is a target fluid 72 that does not contain organic impurities 74 and refers to a fluid that is compared with an unknown target fluid 72 for which it is not known whether it contain organic impurities 74. In some embodiments, the SPR sensor 100A may set the reflectance of the target fluid 72 in the first case C1 to a reference reflectance, and measure the reflectance of the target fluid 72 in the second case C2 to derive a difference between the reflectance of the target fluid 72 and the reference reflectance.

According to embodiments, an adhesive layer 22 may be arranged between the sensor chip 20 and the prism 12. If the metal layer 24 of the sensor chip 20 is difficult to be formed directly on the top surface of the prism 12, the adhesive layer 22 may be formed on the prism 12 prior to the formation of the metal layer 24. The adhesive layer 22 and the metal layer 24 formed on the adhesive layer 22 have an alloy-like stability, such that a stable bond between the metal layer 24 and the prism 12 may be achieved.

In some embodiments, the adhesive layer 22 may include titanium (Ti), tungsten (W), molybdenum (Mo), chromium (Cr), silicon (Si), nickel (Ni), tantalum (Ta), yttrium (Y), vanadium (V), magnesium (Mg), cobalt (Co), tin (Sn), niobium (Nb), hafnium (Hf), or an alloy thereof, but is not limited to the above examples. For example, the thickness of the adhesive layer 22 may be in a range of about 1 nm to about 10 nm, or about 2 nm to about 5 nm.

According to embodiments, the prism 12 may be formed of a dielectric having a high refractive index. In some embodiments, the prism 12 may include optical glass such as BK7, SF11, LASFN9, LAK34, LAF7, F2, SF2, LASF45, LAK34, LAK33A, and LAK33B, but is not limited to the above examples. The cross-sectional shape of the prism 12 may have a semicircular shape, a triangular shape, a parallelogram shape, an inverted trapezoid shape, or a semicircular cylinder shape.

According to embodiments, the metal layer 24 may include free electrons capable of causing an SPR phenomenon. In some embodiments, the metal layer 24 may include copper (Cu), aluminum (Al) or a noble metal such as gold (Au), silver (Ag), palladium (Pd), or platinum (Pt), or an alloy or multilayer structure thereof, but is not limited to the above examples.

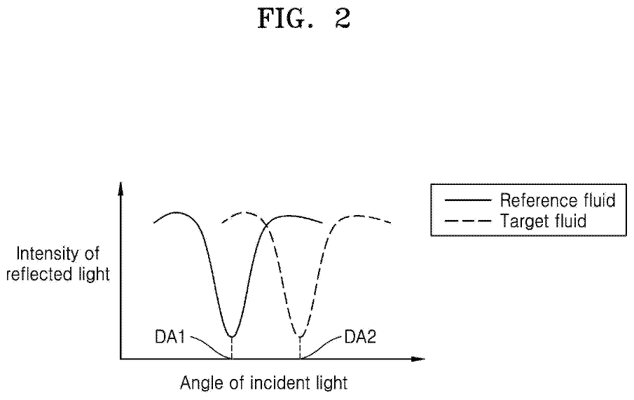

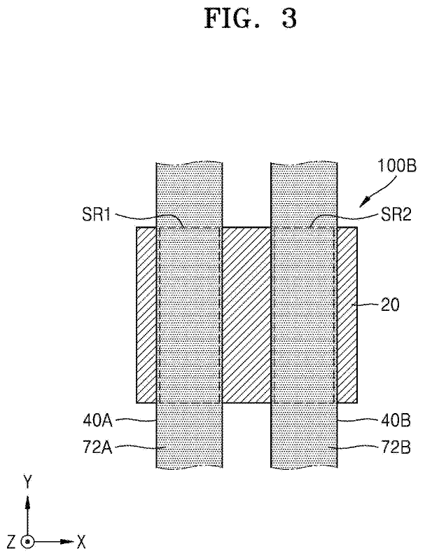

In some embodiments, the thickness of the metal layer 24 may be about 40 nm to about 60 nm. In some embodiments, the thickness of the metal layer 24 may range from about 45 nm to about 55 nm. As will be described below with reference to FIG. 2, the SPR reflectance curve may have a shape similar to that of a downwardly convex secondary function, and when the thickness of the metal layer 24 is within the above range, the width of the SPR reflectance curve may be narrowed, which may be advantageous for sensing organic impurities 74. In addition, when the thickness of the metal layer 24 is too thin, the roughness of the surface may increase and the sensitivity of the sensor chip 20 may decrease. In some embodiments, the thickness of the metal layer 24 could be about 50 nm.

According to embodiments, the recognition layer 26 includes a portion in direct contact with the target fluid 72 and may have an affinity difference for each of the target fluid 72 and the organic impurities 74. In some embodiments, the affinity between the recognition layer 26 and the organic impurities 74 may be greater than the affinity between the recognition layer 26 and the target fluid 72. In the present specification, “affinity” means a force that induces adsorption on the recognition layer 26. For example, the organic impurities 74 may be adsorbed to the recognition layer 26, and SPR sensor 100A may measure changes in reflectance due to adsorption of organic impurities 74. According to embodiments, adsorption of the organic impurities 74 and the recognition layer 26 may be achieved by non-covalent bonds including van der Waals force, ion dipole force, and ion-induced dipole force, but may not be achieved by covalent bonds. Accordingly, the organic impurities 74 may be relatively smoothly separated according to the flow of the target fluid 72 without a separate cleaning process for removing the adsorbed organic impurities 74, and the upper surface of the recognition layer 26 may be recovered as before the organic impurities 74 are adsorbed.

In some embodiments, the thickness of the recognition layer 26 may be about 0.01 nm to about 10 nm, but is not limited to the above range. For example, the thickness of the recognition layer 26 may be about 10 nm to about 150 nm.

According to embodiments, the channel 40 may extend in a Y direction on the recognition layer 26, and the target fluid 72 may flow in one horizontal direction 70 in the inner space of the channel 40 and contact the recognition layer 26. In some embodiments, the SPR sensor 100A may be a single channel type in which one channel 40 is connected to the sensor chip 20.

According to embodiments, the recognition layer 26 may include a sensing region SR overlapping the channel 40 in the vertical direction (Z direction). According to embodiments, the channel 40 may be connected to the recognition layer 26 in the sensing region SR, and the recognition layer 26 may be in direct contact with the target fluid 72 flowing inside the channel 40 in the sensing region SR. The light source 14 irradiates light toward the sensing region SR under the sensor chip 20. For example, in the sensing region SR, the recognition layer 26 may form the bottom of the channel 40, and the target fluid 72 may flow in the inner space of the channel 40, which is partially limited by the upper surface of the recognition layer 26.

According to embodiments, the organic impurities 74 in the target fluid 72 may be adsorbed and desorbed to and from the recognition layer 26. As illustrated in FIG. 1C, in the second case C2 containing the organic impurities 74 in the target fluid 72, the organic impurities 74 may be adsorbed and desorbed to and from the sensing region SR of the recognition layer 26. For example, the organic impurities 74 may be adsorbed on the recognition layer 26 in a first local sensing region LSR1, which is a part of the sensing region SR, and the organic impurities 74 adsorbed on the recognition layer 26 in a second local sensing region LSR2, which is another part of the sensing region SR, may be desorbed from the recognition layer 26.

In the SPR sensor 1 according to embodiments, the target fluid 72 in the first case C1, which does not include the organic impurities 74 illustrated in FIG. 1B, and the target fluid 72 in the second case C2, which includes the organic impurities 74 illustrated in FIG. 1C, may have different SPR reflectance, and the difference between the two may be used to sense whether the organic impurities 74 are present in the target fluid 72.

The light source 14 may emit light to have an incident angle θ with respect to the metal layer 24 through the prism 12. When the wave vector of the plasmon excited on the surface of the metal layer 24 and the wave vector of the evanescent of the incident light have the same frequency, the SPR phenomenon may occur. At the angle at which the SPR phenomenon occurs, most of the energy of the incident light resonates with the surface plasmon and is lost as the incident light travels along the metal surface, and the reflectance is rapidly reduced. The SPR sensor 100A may measure the intensity of light received through the detector 16 to measure the reflectance according to the incident angle θ. In addition, an angle at which reflectance decreases sharply due to an SPR phenomenon may be measured through the SPR sensor 100A. Herein, the angle of the point at which the reflectance becomes the lowest due to the SPR phenomenon may be referred to as a dip angle.

FIG. 2 is an SPR reflectance curve showing a change in reflectance according to an incident angle θ to explain the principle of sensing organic impurities 74 in the target fluid 72 of the SPR sensor 100A according to embodiments. Specifically, FIG. 2 shows the change in reflectance according to the angle of incident angle θ for each of a reference fluid that does not contain organic impurities 74, and a target fluid 72. Specifically, FIG. 2 shows an SPR reflectance curve of the target fluid 72 including the organic impurities 74.

Referring to FIG. 2, the SPR reflectance curve of the reference fluid and the SPR reflectance curve of the target fluid 72 may each have a dip angle that is a point at which the reflectance is lowest. The SPR reflectance curve of the reference fluid has a first dip angle DA1, and the SPR reflectance curve of the target fluid 72 has a second dip angle DA2.

In the first case, C1, the target fluid 72 does not contain organic impurities 74 and thus has the same composition as the reference fluid, and in this case, unlike the one illustrated in FIG. 2, the SPR reflectance curve of the target fluid 72 overlaps the SPR reflectance curve of the reference fluid. In this case, the first dip angle DA1 and the second dip angle DA2 are the same as each other.

In the second case C2, the target fluid 72 includes organic impurities 74, and the SPR reflectance curve of the target fluid 72 has a shifted open from the reflectance SPR curve of the reference fluid, as illustrated in FIG. 2. In this case, the first dip angle DA1 of the second case C2 and the second dip angle DA2 of the second case C2 are different from each other.

The optical properties of the surface of the metal layer 24 are different from each other when the organic impurities 74 are not adsorbed on the recognition layer 26 (first case C1) and when the organic impurities 74 are adsorbed on the recognition layer 26 (second case C2). The difference between the second dip angle DA2 of the first case C1 and the second dip angle DA2 of the second case C2 is due to the difference in optical properties of the surface of the metal layer 24 of each of the first and second cases C1 and C2.

In some embodiments, the SPR reflectance curve of the reference fluid and the SPR reflectance curve of the target fluid 72 are compared with each other to obtain a difference therebetween to determine whether the organic impurities 74 in the target fluid 72 are present. It is observed that the second dip angle DA2 of the target fluid 72 containing organic impurities 74 is shifted from the first dip angle DA1 of the reference fluid. The degree to which the dip angle is shifted may vary depending on the concentration of the organic impurities 74 in the target fluid 72.

In some embodiments, the SPR reflectance curve of the first case C1 may be used as reference data when organic impurities 74 are not included in the target fluid 72, and the presence of organic impurities 74 in the target fluid 72 may be confirmed by comparing the SPR reflectance curve for any target fluid 72 with the SPR reflectance curve of the first case C1. For example, when setting the SPR reflectance curve of the first case C1 as a reference reflectance, it is observed that the second dip angle DA2 of the second case C2 is shifted from the second dip angle DA2 of the first case C1, and accordingly, the presence of organic impurities 74 may be sensed.

Referring back to FIGS. 1A to 1C, the light source 14 may emit light in a wavelength range between about 200 nm and about 1000 nm. For example, the light source 14 may irradiate light in a wavelength range of about 500 nm to about 900 nm, about 600 nm to about 800 nm, or about 700 nm to about 800 nm, but is not limited to the above range. In an example, the light source 14 emits light with wavelengths in the visible spectrum, in another example the light source emits light with wavelengths in the infrared spectrum, and in a further example the light source emits light in a wavelength range spanning both the visible and infrared spectrums.

In some embodiments, the detector 16 may measure the intensity of reflected light, and a 2D CMOS image sensor may be used as the detector 16.

According to embodiments, the recognition layer 26 may interact with the organic impurities 74 at a relatively high level when compared to the target fluid 72. The organic impurities 74 may be adsorbed onto the recognition layer 26 to induce a change in the SPR reflectance curve.

In embodiments, the recognition layer 26 may include a carbon-containing layer. For example, the recognition layer 26 may include carbon nanotubes, graphite, and graphene-based compounds. For example, the graphene-based compound may include a graphene layer such as a graphene single layer, a graphene oxide layer, a nitrogen-doped (N-doped) graphene layer, and a graphene oxide-chitosan composite layer.

According to embodiments, the target fluid 72 may include various treatment solutions used in semiconductor manufacturing. For example, the target fluid 72 may include an organic solvent as a target for sensing whether organic impurities 74 are present. The organic solvent may include, for example, a solvent of various compositions including a hard mask composition, a photoresist composition, and the like used in a semiconductor manufacturing process, a cleaning chemical, and a rinse chemical, but is not limited to the above examples. In the present specification, the target fluid 72 may be referred to as a matrix.

In some embodiments, the target fluid 72 may include an alcohol and/or a glycol ether, but many other target fluids are possible. In some embodiments, the target fluid 72 may include n-propyl alcohol, isopropyl alcohol, 1-butyl alcohol, 2-butyl alcohol, isobutyl alcohol, tert-butyl alcohol, 1-pentanol, 2-pentanol, 3-pentanol, tert-pentyl alcohol, neopentyl alcohol, 2-methyl-1-butanol, 3-methyl-1-butanol, 3-methyl-3-pentanol, cyclopentanol, 1-hexanol, 2-hexanol, 3-hexanol, 2,3-dimethyl-2-butanol, 3,3-dimethyl-1-butanol, 3,3-dimethyl-2-butanol, 2-ethyl-1-butanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-2-pentanol, 4-methyl-3-pentanol, cyclohexanol, 1-octanol, ethylene glycol, polyethylene glycol, ethylene glycol monomethyl ether, ethylene glycolonoethyl ether, diethylene glycol ethyl ether, propylene glycol monomethyl ether, ethylene glycol monomethyl ether acetate, ethylene glycol monoethyl ether acetate, propylene glycol monoethyl ether, propylene glycol monomethyl ether acetate, propylene glycol monoethyl ether acetate, methyl lactate, ethyl lactate, methyl ethyl ketone, 2-heptanone, cyclohexanone, and combinations thereof, but are not limited to the above examples. For example, the type of the target fluid 72 is not limited, and may include a pure substance or mixture. Once a specific material is selected as the target fluid 72, the organic impurities 74 include a material different from the specific material and are subject to sensing.

According to embodiments, the organic impurities 74 may interact with the recognition layer 26 to be adsorbed to the recognition layer 26, and may be desorbed from the recognition layer 26 according to the flow of the target fluid 72. As illustrated in FIG. 1C, the organic impurities 74 in the target fluid 72 are adsorbed to the recognition layer 26 through interaction with the recognition layer 26, but may be naturally desorbed from the recognition layer 26 according to the flow of the target fluid 72 without a separate cleaning process due to a relatively weak coupling force.

According to the method of sensing organic impurities using the SPR sensor according to embodiments, the organic impurities 74 may be sensed even if the organic impurities are contained in an infinitesimal amount in the target fluid 72 in a range of about 500 ppb or less. In some embodiments, the concentration of organic impurities 74 in the target fluid 72 may be 400 ppb or less, 300 ppb or less, 200 ppb or less, or about 100 ppb, e.g., in a range of from 100 to 400 ppb.

In addition, the presence of organic impurities 74 may be sensed in real time for the continuous incoming target fluid 72 without interrupting the sensing process to remove (or desorb) the adsorbed organic impurities 74 from the recognition layer 26. Accordingly, the presence of organic impurities 74 may be immediately determined for the target fluid 72 being used in the actual process, without the need to extract and separate portions of the target fluid 72 to determine whether organic impurities 74 are present in the target fluid 72.

In some embodiments, the recognition layer 26 may be a graphene single layer, and the organic impurity 74 may be adsorbed through a pi-pi interaction with the graphene single layer of the recognition layer 26. The pi-pi interaction is a kind of van der Waals forces and has an attractive force smaller than the covalent bond. For example, the recognition layer 26 may have a surface configured to adsorb organic impurities 74 through pi-pi interaction. For example, the organic impurities 74 are adsorbed on the recognition layer 26, through a pi-pi-interaction between the organic impurities 74 and the recognition layer 26, causing a difference in the SPR signals to allow the organic impurities 74 in the target fluid 72 to be sensed.

In some embodiments, the organic impurities 74 may include an aromatic compound. The aromatic compound may have the planarity of the ring and the delocalization of pi electrons, so the aromatic compound may easily interact with the graphene single layer in the recognition layer 26. The aromatic compound may be a mono- or polycyclic aromatic compound such as a mono- or polycyclic aromatic hydrocarbon.

For example, the organic impurities 74 may include acenaphthene, acenaphthylene, anthracene, benzene, nitrobenzene, phenol, 2-nitrophenol, 2,4-dinitrophenol, toluene, benzidine, benz[a]anthracene, dibenz[a,h]anthracene, pyrene, benzo[a]pyrene, benz[e]acephenanthrylene, benzo[ghi]perylene, fluoranthene, benzo[k]fluoranthene, phthalate, dimethyl phthalate, diethyl phthalate, butyl benzyl phthalate, cresol, chrysene, 3,3′-dichlorobenzidine, hydrazobenzene, phenanthrene, fluorine, anisole, bensulide, 4,4′-methylenedianiline, quinoline, and derivatives thereof. That is, according to embodiments, impurities such as the examples described above may be detected.

In some other embodiments, the recognition layer 26 may be a graphene oxide-chitosan composite layer, and the organic impurities 74 may be adsorbed through interaction with functional groups such as amino groups and hydroxyl groups contained in the graphene oxide-chitosan composite layer of the recognition layer 26. The interaction includes dispersion force and ion-ion interaction, and has an attraction smaller than that of covalent bonds. For example, the recognition layer 26 may have a surface configured to adsorb organic impurities 74 through ion-ion interaction. For example, the organic impurities 74 are adsorbed on the recognition layer 26, through an interaction between the organic impurities 74 and the recognition layer 26, causing a difference in the SPR signals to allow the organic impurities 74 in the target fluid 72 to be sensed.

In some embodiments, the SPR sensor 100A including the recognition layer 26 made of a graphene oxide-chitosan composite layer may sense organic impurities 74 including aromatic compounds. In some embodiments, the organic impurities 74 may include an organic compound having a molecular weight of about 180 or more. Within the range described above, the organic impurities 74 may be easily adsorbed and desorbed to and from the recognition layer 26 formed of the graphene oxide-chitosan composite layer. In some embodiments, the organic impurities 74 may include anions and/or metal ions that can be absorbed on amino groups and/or hydroxyl groups of the graphene oxide-chitosan composite layer. In some embodiments, the organic impurities 74 may include a chain or ring aliphatic hydrocarbon group of C18 to C40 substituted or unsubstituted, and the chain may include a linear or branched chain. The substituent may include an amino group, a hydroxyl group, a carboxyl group, an aldehyde group, a carbonyl group, and/or a vinyl group, but is not limited thereto. For example, the organic impurities 74 may include an acid such as oleic acid, linoleic acid, palmitic acid, palmitoleic acid, elaidic acid, erucic acid, ricinoleic acid, and derivatives thereof, but are not limited thereto.

In some other embodiments, the recognition layer 26 may be a nitrogen-doped graphene layer. The organic impurities 74 may be adsorbed onto the recognition layer 26 by electrostatic attraction induced by nitrogen doping of the recognition layer 26. For example, the nitrogen-doped graphene layer may be a graphene single layer in which a defect is formed through nitrogen plasma. For example, the recognition layer 26 may have a surface configured to adsorb organic impurities 74 through electrostatic attraction. The organic impurities 74 may include an organic compound having a relatively low molecular weight. In some embodiments, the organic impurities 74 may include an organic compound having a molecular weight of about 180 or less. Within the above range, the organic impurities 74 may be easily adsorbed and desorbed to and from the recognition layer 26 consisting of a nitrogen-doped graphene layer. In some embodiments, the organic compound may include a chain or ring aliphatic hydrocarbon group of C3 to C17 substituted or unsubstituted, and the chain may include a linear or branched chain. The substituent may include an amino group, a hydroxyl group, a carboxyl group, an aldehyde group, a carbonyl group, and a vinyl group, but is not limited thereto. For example, organic impurity 74 may include 2-pentanone, 2-butanol, n-propanol, 1-dodecene, 3-methyl-1-butanol, 3-methyl-3-pentanol, cyclopentanol, 1-hexanol, 2-hexanol, 3-hexanol, and 2,3-dimethyl-2-butanol, but is not limited to the examples described above.

In some embodiments the SPR sensor 100A may include a signal amplification layer (not shown) between the metal layer 24 and the recognition layer 26. For example, such a signal amplification layer may perform a role of amplifying an SPR signal, and accordingly, a dip angle may be more clearly observed in an SPR response curve. For example, such a signal amplification layer may contain lithium fluoride (LiF) and magnesium fluoride (MgF₂), but is not limited thereto.

FIG. 3 is a plan view illustrating a surface plasmon resonance (SPR) sensor 100B according to other embodiments. The main difference between FIGS. 1A and 3 is based on whether the SPR sensor 100B includes two channels 40A and 40B. In FIG. 3, the same reference numerals as in FIGS. 1A to 1C denote the same members, and a detailed description thereof will be omitted.

Referring to FIG. 3, the SPR sensor 100B may include a first channel 40A and a second channel 40B spaced apart from the first channel 40A. According to embodiments, the recognition layer 26 may include a first sensing region SR1 connected to the first channel 40A, and a second sensing region SR2 independent of the first sensing region SR1 and connected to the second channel 40B. For example, the SPR sensor 100B may be a double-channel type in which two channels 40A and 40B are connected to the sensor chip 20.

According to embodiments, a first target fluid 72A may flow in a second horizontal direction (Y direction) in the first channel 40A and contact the first sensing region SR1, and a second target fluid 72B may flow in the second horizontal direction (Y direction) in the second channel 40B and contact the second sensing region SR2. According to embodiments, the first target fluid 72A and the second target fluid 72B are physically separated from each other and processed in different sensing regions, but are detected under the same conditions. For example, the first target fluid 72A and the second target fluid 72B may share external factors such as temperature or vibration. In some embodiments, the flow rates of the first target fluid 72A and the second target fluid 72B may be the same.

According to embodiments, the first target fluid 72A may be a reference fluid that does not contain organic impurities 74, and the second target fluid 72B may be a target fluid to determine whether to contain organic impurities 74 therein. For example, the first target fluid 72A of the SPR sensor 100B may be a clean fluid that does not contain organic impurities 74 as the target fluid 72 of the first case C1 described with reference to FIG. 1B. In the present specification, the first target fluid 72A may be referred to as a reference fluid.

According to embodiments, the SPR sensor 100B may simultaneously measure the SPR signal for each of the first target fluid 72A and the second target fluid 72B. For example, the SPR sensor 100B may simultaneously measure the first SPR signal for the reference fluid and the second SPR signal for the second target fluid 72B, as well as provide a difference between the first SPR signal and the second SPR signal to check in real time whether the second target fluid 72B contains organic impurities 74. Accordingly, an error due to an external factor may be reduced by measuring the SPR signal of the second target fluid 72B under the same condition as the condition of the reference fluid.

In FIG. 3, the SPR sensor 100B according to the embodiments illustrated a structure in which two channels 40A and 40B are connected to the sensor chip 20, but is not limited thereto. For example, at least three channels may be connected to the SPR sensor 100B, and different types of fluids may flow through the three or more channels, respectively. Alternatively, the two (or more) channels of FIG. 3 may have different recognition layers, such as where a first recognition layer and a second (third, fourth etc.) recognition layer are formed from different types of graphene (or other SPR) layers, such as a graphene single layer, a graphene oxide layer, a nitrogen-doped (N-doped) graphene layer, a graphene oxide-chitosan composite layer, etc. and where the first and second graphene layers are not the same. As such the first graphene layer may have greater sensitivity to a first (or first group) of contaminant(s) and the second graphene layer may have a greater sensitivity to a second (or second group) of contaminant(s) different from the first/first group.

Hereinafter, an organic impurity sensing method using an SPR sensor will be described in more detail.

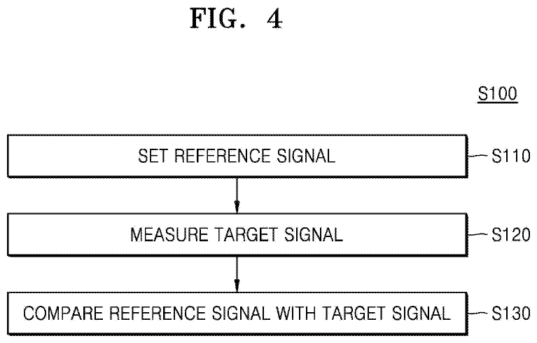

FIG. 4 is a flowchart illustrating a method S100 of sensing organic impurities using an SPR sensor according to embodiments.

Hereinafter, an organic impurity sensing method S100 using an SPR sensor is described with reference to FIGS. 1A to 1C and 3 as well as FIG. 4, and a detailed description of members according to the same reference numerals as FIGS. 1A to 1C and 3 is omitted.

Referring to FIG. 4, the organic impurity sensing method S100 using an SPR sensor includes setting a reference signal (S110), measuring a target signal (S120), and comparing the reference signal with the target signal (S130).

If some embodiments may be implemented differently, certain operations may be performed differently from the order described. For example, the two operations described consecutively may be performed substantially simultaneously, or in the opposite order to the order described.

According to embodiments, a reference signal may be set before measuring the target signal (S110). The reference signal refers to an SPR signal of a reference fluid that does not include organic impurities 74.

In some embodiments, a single-channel type SPR sensor 100A may measure the reference signal by measuring the SPR signal from the reference fluid. For example, before injecting an unknown target fluid 72 into the channel 40 (Here, the unknown target fluid 72 refers to a target fluid to be sensed that has a specific type of the target fluid 72 but cannot determine whether impurities exist), a clean reference fluid that does not contain organic impurities 74 may be injected first. An SPR signal may be measured from a reference fluid flowing through the channel 40, and the SPR signal of the reference fluid may be set as a reference signal.

In some other embodiments, in the single-channel type SPR sensor 100A, the reference signal may be measured by measuring the SPR signal of the target fluid 72 unknown to the channel 40. For example, the SPR signal may be measured from the unknown target fluid 72 injected into the channel 40, waited for the SPR signal to converge, and then the converged SPR signal may be set as the reference signal. The method of setting a reference signal from an unknown target fluid 72 may be used, for example, when organic impurities 74 are found at a low probability, targeting a generally clean target fluid 72 through pretreatment and the like.

In some other embodiments, the reference signal may be set to data embedded in the SPR sensor 100A. For example, the SPR sensor 100A may include a database of theoretical/experimental SPR signals according to various measurement conditions for various types of target fluids 72. The reference signal may be corrected in real time according to a measurement condition of the target fluid 72. In some embodiments, the type of target fluid 72 may be selected manually, and the reference signal may be set to a value corresponding to the selected target fluid 72 in the database.

In some other embodiments, a double-channel type SPR sensor 100B may inject the unknown target fluid 72 into the second channel 40B, simultaneously inject the reference fluid into the first channel 40A, and measure the SPR signal from the reference fluid in contact with the first sensing region SR1, to set a reference signal. The reference signal may be measured in real time and may represent a variation according to an external factor in real time. The reference signal may be measured and set at the same time when measuring the target signal from the target fluid 72 flowing through the second channel 40B. In this case, the reference and target signals may be measured and compared together in real time, thereby avoiding errors due to external factors.

According to embodiments, the target signal may be measured (S120). The target fluid 72 may flow continuously in the channel 40, and the target signal may be measured from the target fluid 72 in contact with the sensing region SR. The target signal may be, for example, an SPR reflectance measured using the SPR sensor 100A or 100B.

Because the target fluid 72 flows continuously through the tubular channel 40, the target fluid 72 introduced into the channel 40 passes through the sensing region SR in the order in which the target fluid 72 is introduced, contacts the recognition layer 26, and then flows out. The front end and the rear end of the target fluid 72 may each have different compositions, and accordingly, the SPR reflectance curve at the front end and the SPR reflectance curve at the rear end may have different values. According to embodiments, the target signal may be measured in real time to sense a change in the SPR reflectance curve according to the flow of the target fluid 72.

According to embodiments, the target signal may be measured using an interaction between the recognition layer 26 and the target fluid 72. The interaction between the recognition layer 26 and the target fluid 72 may be represented through the SPR reflectance curve measured through the SPR sensor.

In the first case C1, the target fluid 72 that does not contain organic impurities 74 may contact the recognition layer 26 in the sensing region SR. The SPR reflectance curve may be measured according to the interaction between the recognition layer 26 and the target fluid 72 that does not contain organic impurities 74. In this case, the target signal measured from the target fluid 72 may have the same SPR reflectance curve as the reference fluid.

In the second case C2, the target fluid 72 including the organic impurity 74 may contact the recognition layer 26 in the sensing region SR. In the sensing region SR, each of the organic impurities 74 and the target fluid 72 may interact with the recognition layer 26.

According to embodiments, the organic impurities 74 may be adsorbed and desorbed to and from the recognition layer 26. For example, the organic impurities 74 in the target fluid 72 introduced into the channel 40 may first be adsorbed to and immobilized by the recognition layer 26, and then desorbed and flushed out of the sensing region SR with the ongoing flow of the target fluid 72.

As illustrated in FIG. 1C, in the first local sensing region LSR1, which is a partial area of the sensing region SR, organic impurities 74 may be adsorbed to the recognition layer 26 by attraction due to interaction. The organic impurities 74 adsorbed on the recognition layer 26 in the second local sensing region LSR2, which is another part of the sensing region SR, may be detached from the recognition layer 26 by force due to the flow of the target fluid 72. From a microscopic point of view, organic impurities 74 may be adsorbed to the recognition layer 26 in the first local sensing region LSR1, and at the same time, organic impurities 74 may be desorbed from the recognition layer 26 in the second local sensing region LSR2. For example, the operation of adsorbing some of the organic impurities 74 on the sensing region SR to the first local sensing region LSR1 and the operation of desorbing, from the second local sensing region LSR2, others already adsorbed on the second local sensing region LSR2 among the organic impurities 74 on the sensing region SR may overlap in a time-based manner.

From a macroscopic point of view, the target fluid 72 in the second case C2 measured at a certain time may have the same SPR reflectance curve as the organic impurities 74 in the target fluid 72 adsorbed onto the recognition layer 26 at a certain concentration in the sensing region SR. For example, from a microscopic point of view, some of the organic impurities 74 may be adsorbed to the recognition layer 26 and some others of the organic impurities 74 may be desorbed from the recognition layer 26, which may occur at the same rate, forming a similar state to equilibrium. For example, the operation of sensing that some of the organic impurities 74 are adsorbed to the first local sensing region LSR1 and the operation of sensing that some others of the organic impurities are desorbed from the second local sensing region LSR2 may overlap in a time-based manner, and both may occur at the same rate. From a macroscopic point of view, the target signal of the target fluid 72 may have the same SPR reflectance as the organic impurities 74 adsorbed and fixed to the recognition layer 26 at a certain concentration. However, the front end and the rear end of the target fluid 72 may have different compositions, and in this case, the target signal may change over time.

According to the organic impurity sensing method S100 using SPR sensors according to embodiments, sensing is performed on the target fluid 72 that flows continuously, and the presence of organic impurities 74 is sensed by adsorption and desorption of the organic impurities 74 in the target fluid 72 to and from the recognition layer 26. According to embodiments, compared to the case where the organic impurities 74 are fixed to the recognition layer 26, by specific binding, etc., the organic impurities 74 are easily desorbed from the recognition layer 26, so that when the target fluid 72 of the first case C1 flows across sensor chip 20 following the target fluid 72 of the second case C2, a change in the target signal may be observed over time.

The organic impurity sensing method S100 using SPR sensors according to embodiments does not require a separate cleaning process after sensing the organic impurities 74, and thus, continuous changes in the target signal may be observed over time. For example, after the target fluid 72 of the second case C2 flows across sensor chip 20 following the target fluid 72 of the first case C1 so as to cause a change in the SPR reflectance curve due to the presence of the organic impurities 74, a change in the SPR reflectance curve due to the absence of the organic impurities 74 may be again sensed according to the inflow of the target fluid 72 of the first case C1. This continuous sensing may be performed without interruption of the flow of the target fluid 72.

According to embodiments, the presence or absence of organic impurities may be sensed by comparing the reference signal with the target signal (S130).

For example, the presence of organic impurities 74 may be confirmed by the difference between the SPR reflectance curve of the reference fluid and the SPR reflectance curve of the target fluid 72. As described above with reference to FIG. 2, the SPR reflectance curve has a dip angle, and the second dip angle DA2 of the target fluid 72, including organic impurities 74 in the second case C2, has a shape shifted from the first dip angle DA1 of the reference fluid. The difference between the first dip angle DA1 and the second dip angle DA2 may be continuously calculated according to the flow of the target fluid 72, and an SPR response curve showing the difference between the first dip angle DA1 and the second dip angle DA2 may be obtained over time.

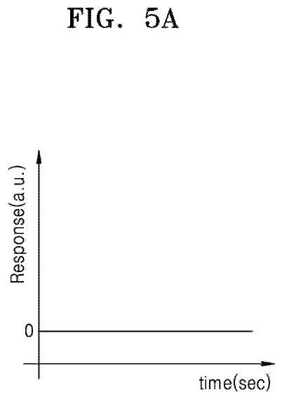

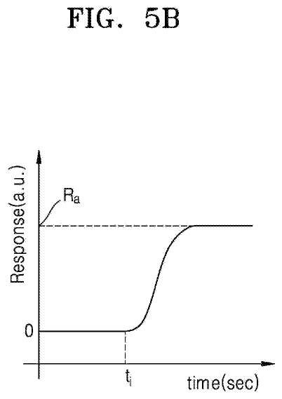

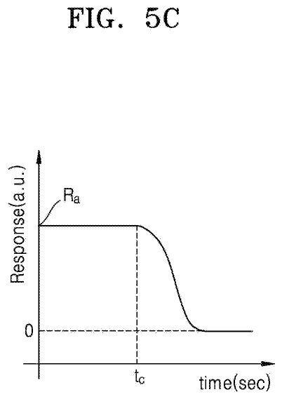

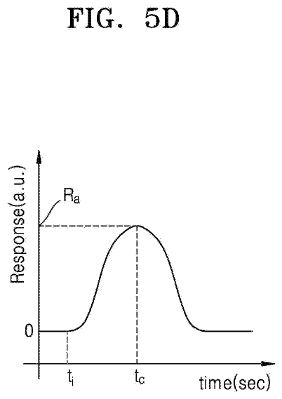

FIG. 5A, FIG. 5B, FIG. 5C, and FIG. 5D are graphs respectively showing SPR response curves according to embodiments.

FIG. 5A illustrates an SPR response curve of the first case C1. Since the target fluid 72 of the first case C1 does not contain organic impurities 74, the target fluid 72 has the same SPR reflectance curve as the reference fluid. Accordingly, since the first dip angle DA1 is not different from the second dip angle DA2, the SPR response curve may have a shape of a straight line having a slope of 0.

FIG. 5B shows an SPR response curve when the target fluid 72 of the second case C2 follows after the target fluid 72 of the first case C1. For example, the target fluid 72 of the first case C1 may flow on the sensing region SR, and then the target fluid 72 of the second case C2 may be introduced at a first time point t₁. From the first time point t₁, the organic impurities 74 begins to be adsorbed on the recognition layer 26, and the difference between the first dip angle DA1 and the second dip angle DA2 (hereinafter, the SPR response value) may increase, and may converge to a first response value R_{A}.

FIG. 5C shows an SPR response curve when the target fluid 72 of the first case C1 follows after the target fluid 72 of the second case C2. For example, the target fluid 72 of the second case C2 may flow across the sensing region SR, and then the target fluid 72 of the first case C1 may be introduced at a second time point t₂. In the SPR response curve, the organic impurities 74 in the target fluid 72 of the second case C2 are adsorbed by the recognition layer 26 and have a first response value R_{A}, and from the second time point t_{c}, the organic impurities 74 begin to be desorbed from the recognition layer 26, so that the SPR response value may decrease and converge to zero.

In FIGS. 5B and 5C, it has been illustrated that the response of the SPR response curve has a certain convergence value (e.g., a first response value R_{A}) because the target fluid 72 of the second case C2 includes a certain concentration of organic impurities 74, but is not limited thereto. For example, the response value of the SPR response curve may vary depending on the concentration of organic impurities 74 and may have a shape of a graph with a slope rather than a certain convergence value as the concentration of organic impurities 74 of the target fluid 72 passing through the sensing region SR varies.

FIG. 5D shows the SPR response curve when the target fluid 72 of the second case C2 follows after the target fluid 72 of the first case C1 and then the target fluid 72 of the first case C1 follows again after the target fluid 72 of the second case C2. For example, the target fluid 72 of the first case C1 may flow on the sensing region SR, the target fluid 72 of the second case C2 may flow at the first time point t₁, and then the target fluid 72 of the first case C1 may flow at the second time point t_{c}. For example, from the first time point t₁, the organic impurities 74 may begin to be adsorbed on the recognition layer 26, causing the SPR response value to increase to the first response value R_{A}, and then from a second time point t_{c}, the organic impurities 74 may begin to be desorbed from the recognition layer 26, causing the SPR response value to converge to zero. As such, the presence of the organic impurities 74 in the target fluid 72 may be continuously observed following the adsorption and desorption of the organic impurities 74, and a separate process to desorb the organic impurities 74 may not be entailed. Accordingly, it is possible to continuously and repeatedly observe the presence or absence of the organic impurities 74 in the target fluid 72.

In some embodiments, the single channel type SPR sensor 100A described with reference to FIGS. 1A to 1C may set a reference signal via a reference fluid or target fluid 72 flowing in a channel 40, and before or after measure a target signal by allowing the target fluid 72 to flow into channel 40 to determine whether it contains organic impurities 74, and compare the reference signal with the target signal. In some embodiments, when a signal stored in the SPR sensor 100A is set as a reference signal, the target fluid 72 may be immediately flowed to measure the target signal without injecting a separate reference fluid into the channel 40 to set the reference signal, and then the target signal may be compared with the embedded reference signal.

In some embodiments, the double-channel type SPR sensor 100B described with reference to FIG. 3 may measure the SPR reflectance curve for the reference fluid in the first sensing region SR1, and at the same time measure the SPR reflectance curve for the target fluid 72 in the second sensing region SR2 spaced apart from the first sensing region SR1. Accordingly, the accuracy of the SPR response curve may be improved by reflecting, in real time, the change in the SPR reflectance curve of the reference fluid according to external factors. In the following, experimental examples, including specific embodiments and comparative examples, are presented to illustrate the inventive concept, but the inventive concept is not limited to the following embodiments.

### Experimental Example 1 SPR Response to Types of Organic Impurities

An adhesive layer 22 consisting of Ti of 5 nm thick was formed by spin coating on a BK7 glass prism 12, and a metal layer 24 consisting of Au of 50 nm thick was formed on the adhesive layer 22. Thereafter, a recognition layer 26 consisting of a graphene single layer (thickness of about 1 nm) was formed on the metal layer 24 to manufacture a sensor chip 20. A light source 14 with a wavelength of 780 nm and a detector 16 which is a 2D CMOS image sensor (Optical sensor class: 1:1/1.8″, Pixel class: 1.3 MP, Resolution: 1280×1024 Pixels) were used.

On the recognition layer 26, a double channel type SPR sensor was manufactured by forming two channels 40A and 40B configured to allow the target fluid 72 to contact the recognition layer 26 at the bottom of the double channel type SPR sensor.

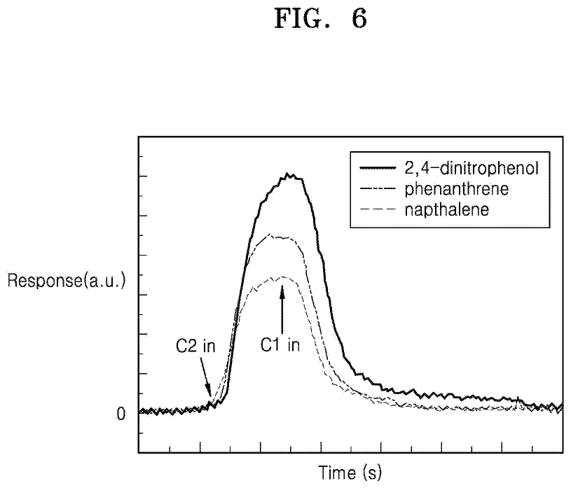

FIG. 6 shows an SPR response curve according to the type of organic impurities 74. Specifically, three SPR response experiments were conducted for three different target fluids 72, each containing 500 ppb of 2,4-dinitrophenol, 500 ppb of phenanthrene, and 500 ppb of naphthalene as organic impurities 74. Isopropyl alcohol (IPA) was used as the target fluid 72.

In each experiment, IPA, which does not contain organic impurities 74, flows in the first channel 40A, as a reference fluid, and at the same time, the target fluid 72 of the first case C1 that does not include the organic impurities 74, and the target fluid 72 of the second case C2 and the target fluid 72 of the first case C1 that include the organic impurities 74, were sequentially injected into the second channel 40B.

Referring to FIG. 6, for the aromatic organic compounds such as 2,4-dinitrophenol, phenanthrene, and naphthalene, certain SPR response values were shown to confirm the sensing performance of the aromatic compounds. In addition, it could be confirmed that all three experiments showed a clear SPR response, even though the experiments were conducted under the condition that each of the organic impurities 74 had an extremely low concentration of 500 ppb. As the target fluid 72 of the first case C1 was flowed and the target fluid 72 of the second case C2 was injected, an SPR response value increased, and as a result of allowing the target fluid 72 of the first case C1 to flow again without a separate cleaning process, it was observed that the SPR response value converged to 0 again. According to the adsorption and desorption mechanism between the organic impurities 74 and the recognition layer 26, it was confirmed that SPR response measurement for the continuously introduced target fluid 72 was possible.

### Experimental Example 2 SPR Response to Concentrations of Organic Impurities

Experiments were conducted under the same conditions as in Experimental Example 1, except that SPR response curves were observed for IPA containing 2,4-dinitrophenol of different concentrations.

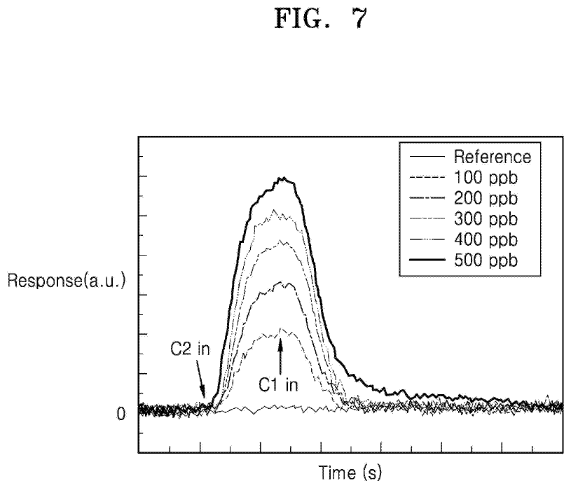

FIG. 7 shows an SPR response curve according to the concentration of organic impurities 74 by using an SPR sensor including a recognition layer 26 composed of a graphene single layer.

Referring to FIG. 7, the response to the target fluid 72 in the range of 100 ppb to 500 ppb of 2,4-dinitrophenol could be confirmed. Specifically, in each experiment, the SPR response curve had an SPR response value of 0 at the beginning of the flow of the target fluid 72 of the first case C1, and the SPR response value increased when the target fluid 72 of the second case C2 was injected. When the target fluid 72 of the first case C1 was injected again, the SPR response value decreased and was converged to 0. As the target fluid 72 of the second case C2 was flowed, the SPR response value increased, confirming the sensing performance of infinitesimal organic impurities 74 (in the range of 100 to 500 ppb). As can be seen in FIG. 7, there is a clear and easily detectable signal difference between 100 ppb and the reference signal. Other amounts less than 100 ppb, such as 50 ppb or 25 ppb, e.g., from 10 to 90 ppb, can also be detected.

### Experimental Example 3 SPR Response Reproducibility

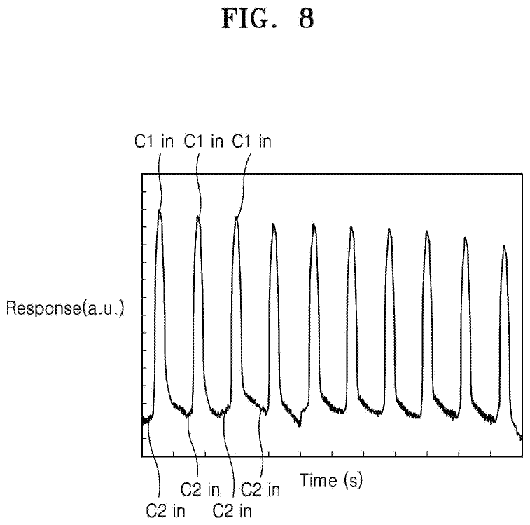

The experiment was conducted under the same conditions as in Experimental Example 1, except that the target fluid 72 of the first case C1, which does not contain organic impurities 74, and the target fluid 72 of the second case C2, which contains 2,4-dinitrophenol at a concentration of 500 ppb, were alternately introduced into the second channel 40B, and the SPR response curve over time was observed and is shown in FIG. 8.

Referring to FIG. 8, as the target fluid 72 of the first case C1 and the target fluid 72 of the second case C2 were alternately introduced thereinto, the SPR response value increased and decreased repeatedly, thereby obtaining an SPR response curve with multiple peaks. It could be confirmed that the organic impurities 74 adsorbed on the recognition layer 26 are desorbed from the recognition layer 26 and flow out when the clean target fluid 72 of the first case C1 is introduced thereinto, and the recognition layer 26 returned to the same state as before the organic impurities 74 were adsorbed. In addition, it could be confirmed that organic impurities 74 could be stably sensed even for continuous and repetitive measurements of the SPR response.

### Experimental Example 4 Changes in SPR Reflectance Curves with or without Recognition Layers

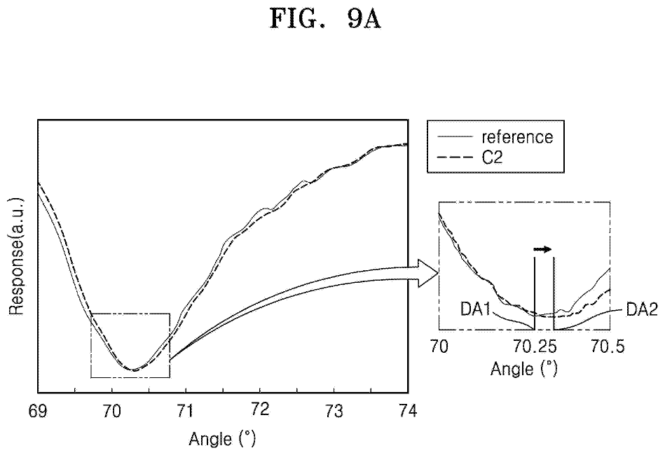

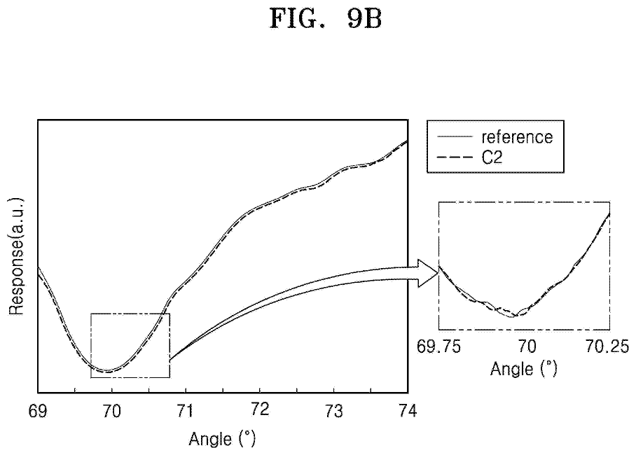

FIG. 9A shows an SPR reflectance curve for each of the target fluid (IPA) 72 of the second case C2 containing organic impurities 74, which are 2,4-dinitrophenol at a concentration of 500 ppm and the reference fluid under the same conditions as Experimental Example 1. FIG. 9B shows an SPR reflectance curve obtained by conducting an experiment under the same conditions as FIG. 5A, except that an SPR sensor according to a comparative example that does not include the recognition layer 26 was used.

Referring to FIG. 9A, it could be confirmed that the SPR reflectance curve of the target fluid 72 in the second case C2 was shifted in the X-axis direction from the SPR reflectance curve of the reference fluid. In addition, it was observed that the second dip angle DA2 of the target fluid 72 was shifted from the first dip angle DA1 of the reference fluid.

In the comparative example that does not include the recognition layer 26, the metal layer 24 directly contacted the target fluid 72 and the organic impurities 74. Referring to FIG. 9B, since the SPR sensor according to the comparative example does not include the recognition layer 26, there was little difference between the SPR reflectance curve for the reference fluid and the SPR reflectance curve for the target fluid 72 and thus it was observed that the two curves overlapped. Due to the weak interaction between the organic impurities 74 and the metal layer 24, the impurities 74 had no or very little effect on the optical properties of the surface of the metal layer 24, and thus, the SPR reflectance curve of the target fluid 72 appeared to be almost the same as the SPR reflectance curve of the reference fluid. Since there is little difference between the first dip angle DA1 and the second dip angle DA2, the difference expressed as an SPR response curve, could be expected that the SPR response value could have 0 or appear as noise near 0. Comparative examples that do not include the recognition layer 26 cannot use the adsorption mechanism due to the interaction between the organic impurities 74 and the surface of the SPR sensor, thereby making it difficult to determine whether organic impurities 74 were present in the target fluid 72.

### Experimental Example 5 Changes in Electric Field and SPR Reflectance Curves with Thickness of Metal Layer

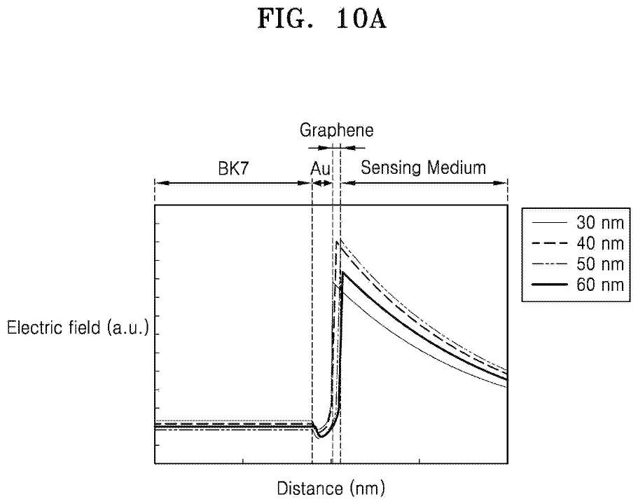

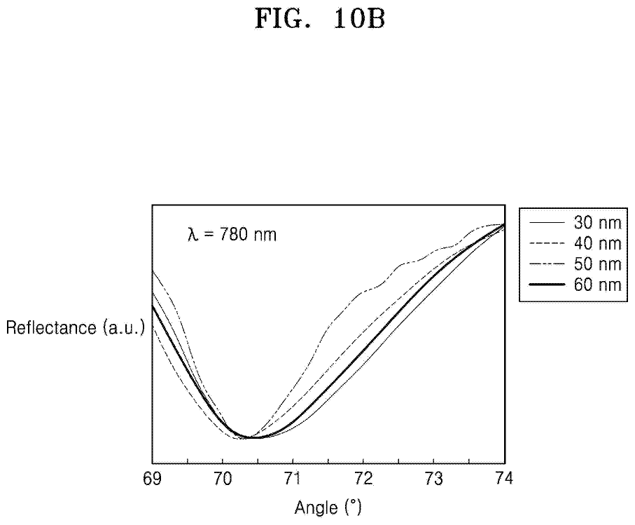

Four SPR sensors having the metal layer 24 of 30 nm, 40 nm, 50 nm, or 60 nm thick were manufactured. The electric field according to the vertical (Z-direction) position of each of the four SPR sensors was calculated through Finite-difference time-domain (FDTD) simulation and shown in FIG. 10A, and the SPR reflectance of the target fluid (IPA) 72 of the second case 74 was measured using each of the four SPR sensors and shown in FIG. 10B.

Referring to FIG. 10A, when compared to the case where the thickness of the metal layer 24 was 30 nm or 60 nm, it could be confirmed that the strength of the electric field was maximized near the recognition layer 26 (graphene single layer). When the thickness of the metal layer 24 was 40 nm or 50 nm. Referring to FIG. 10B, when compared to the case where the thickness of the metal layer 24 was 30 nm or 60 nm, it could be confirmed that the width of the SPR reflectance curve according to the x-axis with a quadratic function-like shape decreased when the thickness of the metal layer 24 was 40 nm or 50 nm, particularly, it could be confirmed that the width of the SPR reflectance curve according to the x-axis was very narrow when the thickness of the metal layer 24 was 50 nm. When the width of the SPR reflectance curve along the x-axis was narrow, it was more advantageous for dip angle observation, and the shift of the dip angle according to the presence of organic impurities 74 could also be observed more clearly.

According to an organic impurity sensing method using an SPR sensor according to embodiments, a metal layer 24 having a thickness in the range of about 35 nm to about 55 nm, about 40 nm to about 55 nm, or about 45 nm to about 55 nm could be used. Within the range described above, the intensity of the electric field near the recognition layer 26 was maximized, and the width of the SPR reflectance curve was reduced, which could be advantageous for sensing organic impurities 74. In some embodiments, the thickness of the metal layer 24 could be about 50 nm.

### Experimental Example 6 Recognition Layer Made of Graphene Oxide-Chitosan Composite Layer

Except that a graphene oxide-chitosan composite layer (thickness of about 140 nm) was used as the recognition layer 26 instead of a single graphene layer, the experiment was conducted under the same conditions as Experimental Example 2.

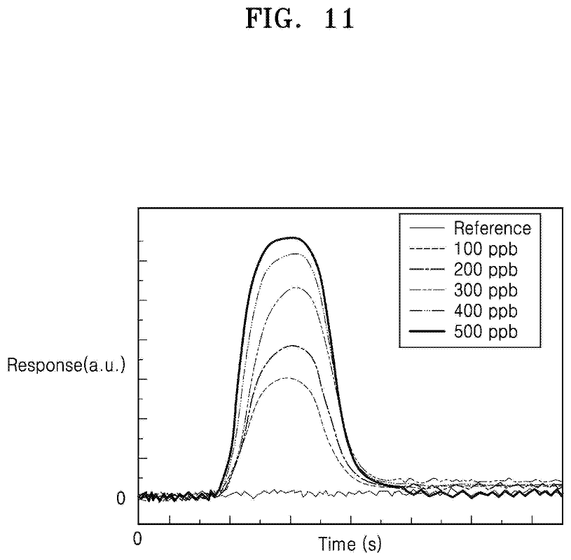

FIG. 11 shows an SPR response curve according to the concentration of organic impurities 74 by using an SPR sensor including a recognition layer 26 composed of a graphene oxide-chitosan composite layer. Referring to FIG. 11, the response to the target fluid 72 in the range of 100 ppb to 500 ppb of 2,4-dinitrophenol could be confirmed. Specifically, in each experiment, the SPR response curve had an SPR response value of 0 at the beginning of the flow of the target fluid 72 of the first case C1, and the SPR response value increased when the target fluid 72 of the second case C2 was injected. When the target fluid 72 of the first case C1 was injected again, the SPR response value decreased and was converged to 0. As the target fluid 72 of the second case C2 was flowed, the SPR response value increased, confirming the sensing performance of infinitesimal organic impurities 74 (in the range of 100 ppb to 500 ppb). As can be seen in FIG. 11, due to the large signal present at 100 ppb, amounts lower than 100 ppb (e.g., from 15 to 95 ppb) can also be detected. Referring to FIGS. 7 and 11, when compared to the case of using a recognition layer 26 made of a graphene single layer, the sensitivity to organic impurities 74 was excellent, resulting in a relatively noise-reduced SPR response curve.

### Experimental Example 7 Recognition Layer Made of Nitrogen-Doped Graphene Layers

Except that a nitrogen-doped graphene layer (thickness of about 1 nm) not the graphene single layer was used as the recognition layer 26 and the type and concentration of organic impurities 74 to be sensed were different, the experiment was conducted under the same conditions as Experimental Example 2.

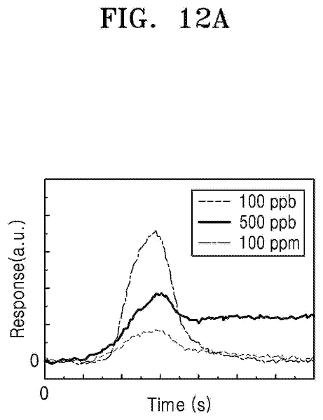

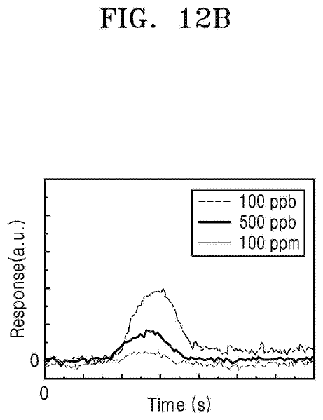

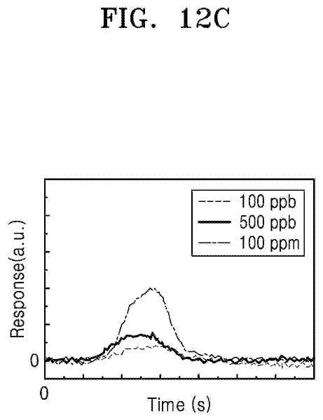

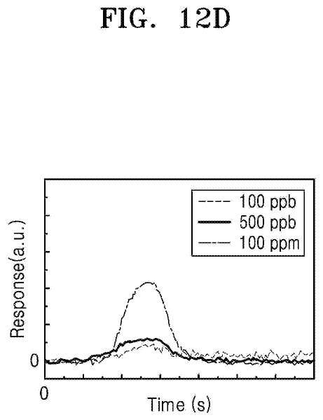

FIG. 12A shows an SPR response curve measured by varying a concentration with respect to 2-pentanol, FIG. 12B shows an SPR response curve measured by varying the concentration for 2-butanol, FIG. 12C shows an SPR response curve measured by varying concentrations with respect to n-propanol, and FIG. 12D shows an SPR response curve measured by varying concentrations with respect to 1-dodecin. Referring to FIGS. 12A to 12D, it was confirmed that 2-pentanol, 2-butanol, n-propanol, and 1-dodecin, which are organic compounds with relatively less molecular weights, could be sensed through SPR sensors even when contained in IPA at concentrations of 100 ppb, 500 ppb, and 100 ppm.

As described above, the organic impurity sensing methods using the SPR sensor 100A or 100B illustrated in FIGS. 1A to 1C and 3 have been described with reference to FIGS. 1A to 12. However, from the foregoing description with reference to FIGS. 1A through 12, it will be apparent to those skilled in the art that organic impurities may be sensed by various methods, with various modifications and alterations within the scope of the technical ideas of the inventive concept.

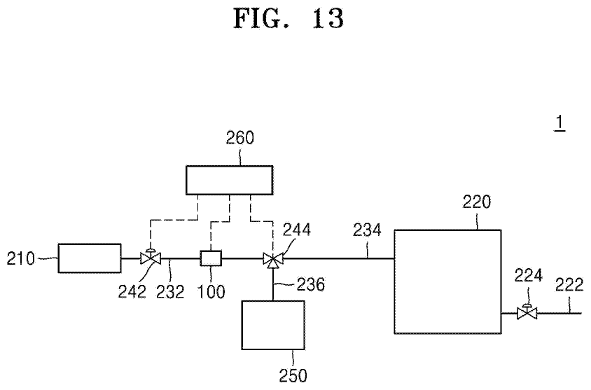

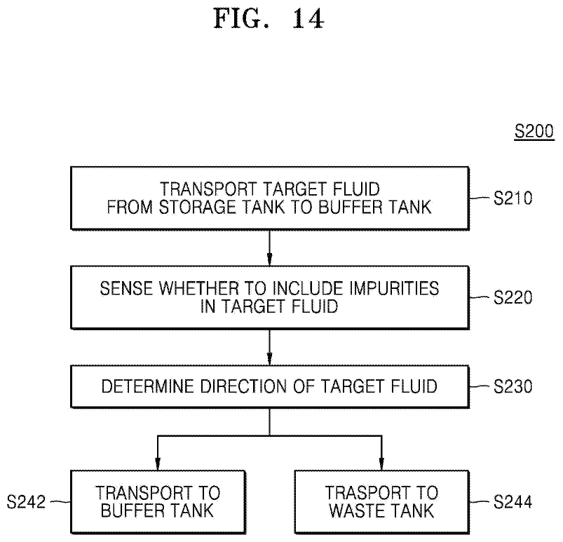

FIG. 13 is a block diagram illustrating an organic impurity sensing system 1 including an SPR sensor according to embodiments. FIG. 14 is a flowchart illustrating a method S200 of sensing organic impurities using an organic impurity sensing system including an SPR sensor according to embodiments. The SPR sensor 100A or 100B described with reference to FIGS. 1A to 1C and 3 may be used as the SPR sensor 100 of FIG. 11, and a detailed description thereof will be omitted. The organic impurity sensing method S100 using an SPR sensor described with reference to FIGS. 1a to 12 may be utilized in the operation of sensing whether the target fluid contains organic impurities (S220) of FIG. 14, and a detailed description thereof will be omitted.

Referring to FIGS. 13 and 14, an organic impurity sensing system 1 including an SPR sensor according to embodiments may include a storage tank 210, a buffer tank 220, and a waste tank 250. The storage tank 210 is configured to receive a target fluid 72 (see FIGS. 1B, 1C), and the target fluid 72 in the storage tank 210 may be transported via a switching valve 244 to the buffer tank 220 or waste tank 250. In the present specification, the storage tank 210 may be referred to as a store tank. The buffer tank 220 may be a space for performing pretreatment such as temperature/pressure control on the target fluid 72 before the target fluid 72 is introduced into the process.

The storage tank 210 may be connected to the switching valve 244 through a connection pipe 232, the buffer tank 220 may be connected to the switching valve 244 through a buffer-side branch pipe 234, and the waste tank 250 may be connected to the switching valve 244 through a waste-side branch pipe 236. For example, the front end of the buffer-side branch pipe 234 may be connected to the switching valve 244, and the rear end of the buffer-side branch pipe 234 may be connected to the buffer tank 220. For example, the front end of the waste-side branch pipe 236 may be connected to the switching valve 244, and the rear end of the waste-side branch pipe 236 may be connected to the waste tank 250. The target fluid 72 in the connection pipe 232 may flow to the buffer-side branch pipe 234 or the waste-side branch pipe 236 starting from the switching valve 244.

According to embodiments, the SPR sensor 100 may be connected to the connection pipe 232. The target fluid 72 may flow along the connection pipe 232 and is in contact with the SPR sensor 100, and the organic impurities 74 in the target fluid 72 may be adsorbed and desorbed to and from the recognition layer 26 (see FIGS. 1B and 1C) of the SPR sensor 100 for sensing.

According to embodiments, the switching valve 244 may be arranged at a rear end of the SPR sensor 100. By sensing organic impurities 74 in the target fluid 72 at the front end and adjusting the switching valve 244 at the rear end, the target fluid 72 in the first case C1 and the target fluid 72 in the second case C2 may be reliably separated from each other.

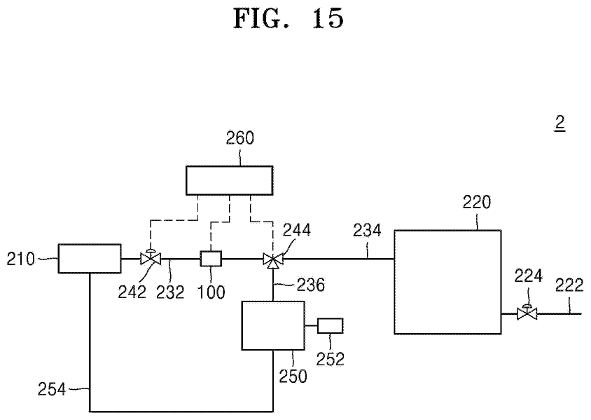

In some embodiments, the SPR sensor 100 may be directly connected to the storage tank 210 and the buffer tank 220, unlike illustrated in FIG. 15. Accordingly, it is possible to independently monitor whether organic impurities 73 exist in the target fluid 72 in the storage tank 210 and the buffer tank 220. For example, the storage tank 210 and the buffer tank 220 may be configured to circulate the target fluid 72 stored therein, and the SPR sensor 100 may be in contact with the target fluid 72 being circulated. Accordingly, when the target fluid 72 in the storage tank 210 and buffer tank 220 contains organic impurities 74, the organic impurities 74 may be adsorbed and desorbed to and from the recognition layer 26 of the SPR sensor 100 and may be sensed as the organic impurities 74 flow with the circulating target fluid 74.

In some embodiments, the target fluid 72 of the storage tank 210 may be adjusted to flow into the connection pipe 232 through a first transport valve 242. In some embodiments, the target fluid 72 of the buffer tank 220 may be discharged to a process pipe 222 through a second transport valve 224. The first transport valve 242 and the second transport valve 224 may be replaced with a pump (not shown).

According to embodiments, the first transport valve 242, the SPR sensor 100, and the switching valve 244 may be connected to the control unit 260. The controller 260 may be configured to adjust the flow rate of the target fluid 72 by adjusting the first transport valve 242. According to embodiments, the SPR sensor 100 may transmit information on the sensing of organic impurities 74 in the target fluid 72 to the control unit 260. Based on the sensing information, the control unit 260 may adjust the switching valve 244 to determine whether to transport the target fluid 72 to the buffer tank 220 or to the waste tank 250.

According to embodiments, the organic impurity sensing method S200 may include: transporting the target fluid 72 from the storage tank 210 toward the buffer tank 220; sensing whether there exists the presence of organic impurities 74 in the target fluid 72; and determining whether to transport the target fluid 72 to the buffer tank 220 or to the waste tank 250. In this specification, the determining of whether to transport the target fluid 72 to the buffer tank 220 or the waste tank 250 (S230) may be referred to as determining the direction of the target fluid 72. When organic impurities 74 are sensed to be absent in the target fluid 72, the target fluid 72 may be transported to the buffer tank 220 (S242). When organic impurities 74 are sensed to be present in the target fluid 72, the target fluid 72 may be transported to the waste tank 250 (S244).

In some embodiments, the waste tank 250 may be configured to accommodate the target fluid 72 including organic impurities 74. In some embodiments, a qualitative analysis of organic impurities 74 may be performed by sampling a portion of the target fluid 72 accommodated in the waste tank 250.

In some embodiments, the SPR sensor 100 may sense that there are no organic impurities 74 in the contacted target fluid 72. Accordingly, the switching valve 244 arranged at the rear end of the SPR sensor 100 may be adjusted to connect the connection pipe 232 with the buffer-side branch pipe 234, and the target fluid 72 of the first case C1 (see FIG. 1B) may be transported to the buffer tank 220. Thereafter, it may be sensed that the organic impurities 74 are present in the target fluid 72 by the SPR sensor 100 at the front end of the SPR sensor 100. In this case, by adjusting the switching valve 244 at the rear end, the connection pipe 232 and the buffer-side branch pipe 234 may be disconnected from each other and the connection pipe 232 and the waste-side branch pipe 236 may be connected with each other to transport the target fluid 72 in the second case C2 (see FIG. 1C) to the waste tank 250.

The switching valve 244 is arranged at the rear end of the SPR sensor 100 and is instantaneously regulated based on the presence of organic impurities 74, so that the target fluid 72 in the first case C1 and the target fluid 72 in the second case C2 may be reliably separated from each other.

In some embodiments, the SPR sensor 100 may sense that there are organic impurities 74 in the contacted target fluid 72. In this case, the switching valve 244 arranged at the rear end of the SPR sensor 100 may be adjusted to connect the connection pipe 232 with the waste-side branch pipe 236, and the target fluid 72 of the second case C2 may be transported to the waste tank 250. Thereafter, the SPR sensor 100 may sense that the organic impurities 74 are not present in the target fluid 72. In this case, the connection pipe 232 and the waste-side branch pipe 236 may be disconnected from each other by adjusting the switching valve 244 at the rear end, and the connection pipe 232 and the buffer-side branch pipe 234 may be connected with each other to transport the target fluid 72 of the first case C1 to the buffer tank 220. For example, when the target fluid 72 begins to be transported to the buffer tank 220 for the first time after filling the empty storage tank 210 with the target fluid 72, the organic impurities 74 present in the storage tank 210 or the connection pipe 232 may be dissolved in the target fluid 72. In this case, the presence of organic impurities 74 may be detected by the SPR sensor 100 and the switching valve 244 may be adjusted at the drain end to transport the target fluid 72 of the second case C2 to the waste tank 250, and when the SPR sensor 100 begins to sense the clean target fluid 72 from the first case C1, the switching valve 244 may be adjusted to transport the target fluid 72 to the buffer tank 220.

In some embodiments, the target fluid 72 of the first case C1 and the target fluid 72 of the second case C2 may flow alternately in the connection pipe 232, and the presence and absence of organic impurities 74 may be sensed alternately by the SPR sensor 100. In this case, the switching valve 244 may be adjusted so that the connection pipe 232 is alternately connected to the buffer-side branch pipe 234 or the waste-side branch pipe 236 according to the change between the target fluid 72 of the first case C1 and the target fluid 72 of the second case C2.

As described with reference to FIGS. 1A to 12, the SPR sensor 100 may be a single channel type SPR sensor 100A or a double channel type SPR sensor 100B, and the reference signal may be set through a separate reference fluid, the target fluid 72 in the storage tank 210, or an embedded database.

FIG. 15 is a block diagram illustrating an organic impurity sensing system 2 including an SPR sensor according to some other embodiments. The difference between FIGS. 13 and 15 is based on whether the organic impurity sensing system 2 including the SPR sensor further includes a purification module 252 and a circulation pipes 254. In FIG. 15, the same reference numerals as those of FIG. 13 denote the same members, and redundant descriptions thereof will be omitted.

Referring to FIG. 15, the organic impurity sensing system 2 may further include a purification module 252 connected to the waste tank 250. In some embodiments, the purification module 252 may be configured to remove organic impurities 74 dissolved in the target fluid 72 of the second case C2 accommodated in the waste tank 250. For example, the purification module 252 may include an active carbon fiber filter, and the target fluid 72 of the second case C2 accommodated in the waste tank 250 may be discharged as the target fluid 72 of the first case C1 that does not contain organic impurities 74 through the active carbon fiber filter.

In some embodiments, the target fluid 72 of the first case C1 discharged through the purification module 252 may be transported to the storage tank 210 through the circulation pipe 254. Although not illustrated, a pump (not illustrated) configured to transport the target fluid 72 through the purification module 252 from the waste tank 250 to the storage tank 210 may be connected to the circulation pipe 254.

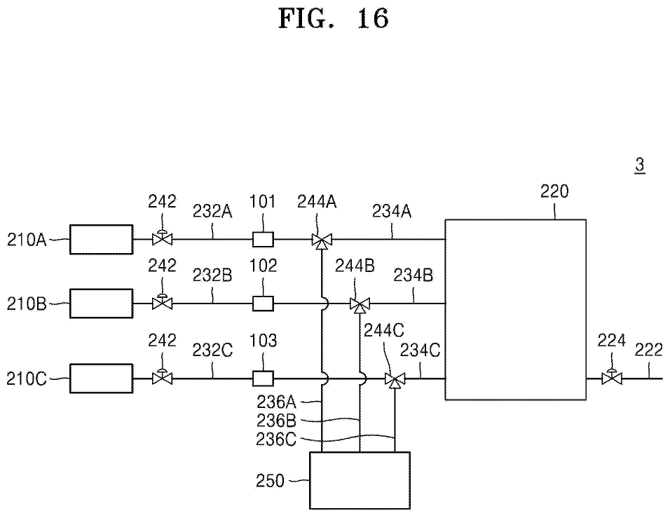

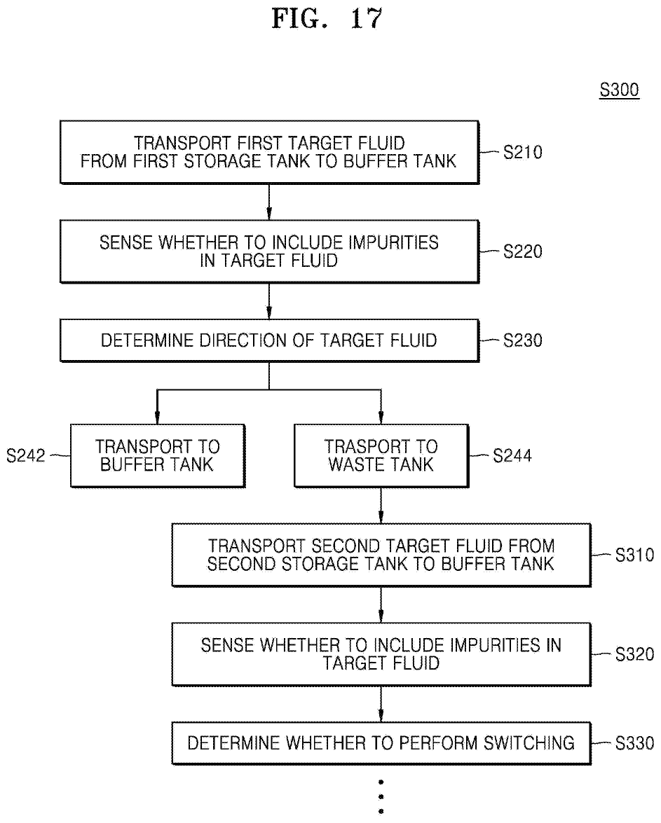

FIG. 16 is a block diagram illustrating an organic impurity sensing system 3 including an SPR sensor according to some other embodiments. FIG. 17 is a flowchart illustrating a method (S300) of sensing organic impurities using an organic impurity sensing system including an SPR sensor according to embodiments.

The first to third storage tanks 210A, 210B, and 230B of FIG. 16 respectively represent the same member as the storage tank 210 of FIG. 13. The first to third SPR sensors 101, 102, and 103 of FIG. 16 each have the same configuration as described for the SPR sensor 100 of FIG. 13. The first to third switching valves 244A, 244B, and 244C of FIG. 16 each represent the same member as the SPR sensor 100 of FIG. 13. The first to third connection pipes 232A, 232B, and 232C of FIG. 16 each have the same configuration as described for the connection pipe 232 of FIG. 13. The first to third buffer-side branch pipes 234A, 234B, and 234C of FIG. 16 each represent the same member as the buffer-side branch pipe 234 of FIG. 13. The first to third waste-side branch pipes 236A, 236B, and 236C of FIG. 16 each have the same configuration as described for the waste-side branch pipe 236 of FIG. 13. In addition, the same reference numerals of FIG. 16 as those of FIG. 13 indicate the same member. Hereinafter, the redundant description thereof will be omitted. In FIG. 17, the same reference numerals as those of FIG. 14 denote the same operations, and redundant descriptions thereof will be omitted.

According to embodiments, a first storage tank 210A is connected to a first switching valve 244A. The first switching valve 244A is connected to the buffer tank 220 via a first buffer-side branch pipe 234A, and to the waste tank 250 via a second waste-side branch pipe 236. The first switching valve 244 may connect the first connection pipe 232A with the first buffer-side branch pipe 234A, or may connect the first connection pipe 232A with a first waste-side branch pipe 236A. At the front end of the first switching valve 244A, a first SPR sensor 101 is connected to the first connection pipe 232A. The second storage tank 210B, the second switching valve 244B, the second buffer-side branch pipe 234B, and the second waste-side branch pipe 236B have a connection relationship corresponding to the first storage tank 210A, the first witching valve 244A, the first buffer-side branch pipe 234A, and the first waste-side branch pipe 236A, respectively. The third storage tank 210C, the third switching valve 244C, the third buffer-side branch pipe 234C, and the third waste-side branch pipe 236C have a connection relationship corresponding to the first storage tank 210A, the first witching valve 244A, the first buffer-side branch pipe 234A, and the first waste-side branch pipe 236A, respectively.

According to embodiments, the first target fluid 72 may be transported from the first storage tank 210A toward the buffer tank 220 (S210). The first SPR sensor 101 may sense whether organic impurities 74 are present in the first target fluid 72 flowing through the first connection pipe 232A (S230). Based on the presence of the organic impurities 74, the destination (i.e., direction of flow) of the target fluid 72 may be determined (S230).

For example, when the first SPR sensor 101 senses that organic impurities 74 are not present in the first target fluid 72, the first switching valve 244A at the rear end of the first SPR sensor 101 may be adjusted to connect the first connection pipe 232A with the first buffer-side branch pipe 234A. In this case, the first target fluid 72 of the first case C1 may be transported to the buffer tank 220.

For example, when the first SPR sensor 101 senses that organic impurities 74 exist in the target fluid 72, the first switching valve 244A at the rear of the first SPR sensor 101 may be adjusted to connect the first connection pipe 232A with the first waste-side branch pipe 236A. In this case, the first target fluid 72 of the second case C2 may be transported to the waste tank 250.

According to embodiments, the second target fluid 72 may be transported from the second storage tank 210B toward the buffer tank 220 (S310).

In some embodiments, the operation S244 of transporting the first target fluid 72 to the waste tank 250 and the operation S310 of transporting the second target fluid 72 may overlap in a time-based manner. In some embodiments, after the first SPR sensor 101 senses organic impurities 74 in the first target fluid 72, the first switching valve 244 may be adjusted to connect the first connection pipe 232A with the first waste-side branch pipe 236A (S244), and at the same time, the second target fluid in the second storage tank 210B may be transported to the buffer tank 220 (S310). Accordingly, the target fluid of the first case C1 that does not include the organic impurities 74 may be continuously introduced into the buffer tank 220.

According to embodiments, the second SPR sensor 102 may sense whether organic impurities 74 are present in the second target fluid 72 flowing through the second connection pipe 232B (S320). Depending on whether organic impurities 74 exist, the direction of the target fluid 72 may be determined (S330).

Similar to the treatment of the first target fluid 72, when organic impurities 74 are sensed to be absent in the second target fluid 72, the second target fluid 72 may be transported to the buffer tank 220, and when organic impurities 74 are detected to be present in the second target fluid 72, the second target fluid 72 may be transported to the waste tank 250. When the second target fluid 72 is transported to the waste tank 250, the third target fluid 72 in the third storage tank 210C may be transported to the buffer tank 220. The treatment of the third target fluid 72 may correspond to the treatment of the first target fluid 72 and the second target fluid 72.

In FIG. 16, the organic impurity sensing system 3 including an SPR sensor has been shown to include, but is not limited to, three storage tanks 210A, 210B, and 210C. The organic impurity sensing system 3 including an SPR sensor may include two or four storage tanks or more. In this case, as described with reference to FIGS. 16 and 17, the transport of a later target fluid 72 may begin depending on whether organic impurities 74 exist in a preceding target fluid 72.

While an organic impurity sensing system including SPR sensors installed in tanks for storing semiconductor chemicals and in pipes for transporting semiconductor chemicals have been described as described above, the technical ideas of the inventive concept are not limited to the above examples. The technical idea of the inventive concept may provide, for example, various organic impurity sensing systems using the organic impurity sensing method using the SPR sensor described with reference to FIG. 4. For example, the technical idea of the inventive concept may provide an organic impurity sensing system including an SPR sensor coupled to a tank lorry used to transport chemicals.

While the inventive concept has been particularly shown and described with reference to embodiments thereof, it will be understood that various changes in form and details may be made therein without departing from the spirit and scope of the following claims.

1. A method of sensing organic impurities in semiconductor chemicals by using a surface plasmon resonance (SPR) sensor, the method comprising:
bringing a target fluid into contact with the SPR sensor; and
sensing a presence of organic impurities in the target fluid by using adsorption of the organic impurities to and desorption of the organic impurities from the SPR sensor.

2. The method of claim 1, wherein the sensing of the organic impurities comprises:
sensing that the organic impurities are adsorbed onto the SPR sensor; and
sensing whether the organic impurities are desorbed from the SPR sensor.

3. The method of claim 2, wherein
the SPR sensor comprises a first local sensing region and a second local sensing region, which are in contact with the target fluid, and
sensing that some of the organic impurities are adsorbed into the first local sensing region, and sensing that some others of the organic impurities are desorbed from the second local sensing region overlap in a time-based manner.

4. The method of claim 1, further comprising desorbing the organic impurities from the SPR sensor by supplying the target fluid to the SPR sensor after the organic impurities are adsorbed into the SPR sensor.

5. The method of claim 1, wherein the bringing of the target fluid into contact with the SPR sensor comprises:
setting a reference signal from the target fluid; and
setting a target signal from the target fluid, and
the sensing the presence of the organic impurities is performed by comparing the reference signal with the target signal.

6. The method of claim 1, further comprising
setting a reference signal from a reference fluid by bringing the reference fluid into contact with the SPR sensor before bringing the target fluid into contact with the SPR sensor, wherein
the bringing of the target fluid into contact with the SPR sensor comprises setting a target signal from the target fluid, and
the sensing the presence of the organic impurities is performed by comparing the reference signal with the target signal.

7. The method of claim 1, wherein
the bringing of the target fluid into contact with the SPR sensor comprises bringing the target fluid into contact with the SPR sensor, and simultaneously bringing a reference fluid separated from the target fluid into contact with the SPR sensor,
the bringing of the target fluid into contact with the SPR sensor comprises setting a reference signal from the reference fluid and setting a target signal from the target fluid, and
the sensing of the organic impurities is performed by comparing the reference signal with the target signal.

8. (canceled)

9. The method of claim 1, wherein the organic impurities are aromatic compounds.

10. The method of claim 1, wherein
the SPR sensor comprises a recognition layer configured to be in contact with the target fluid, and
the organic impurities are adsorbed into the recognition layer by a pi-pi interaction.

11. A method of sensing organic impurities in semiconductor chemicals by using a surface plasmon resonance (SPR) sensor, the method comprising:
bringing a target fluid into contact with a first SPR sensor connected to a pipe connecting a storage tank, a buffer tank, and a waste tank with each other;
sensing, in real time, whether organic impurities are present in the target fluid by using adsorption and desorption of organic impurities to and from the first SPR sensor; and
transporting the target fluid to the buffer tank or the waste tank by adjusting a switching valve connected to the pipe at a rear end of the first SPR sensor.

12. The method of claim 11, wherein the pipe comprises:
a connection pipe to which the first SPR sensor is connected;
a buffer-side branch pipe having a front end connected to the switching valve and a rear end connected to the buffer tank; and
a waste-side branch pipe having a front end connected to the switching valve and a rear end connected to the waste tank, the method further comprising connecting the connection pipe to the buffer-side branch pipe by controlling the switching valve after sensing the absence of the organic impurities.

13. The method of claim 12, further comprising separating the connection pipe from the buffer-side branch pipe, and connecting the connection pipe with the waste-side branch pipe, by controlling the switching valve after sensing the presence of the organic impurities.

14. The method of claim 11, wherein the pipe comprises:
a connection pipe to which the first SPR sensor is connected;
a buffer-side branch pipe having a front end connected to the switching valve and a rear end connected to the buffer tank; and
a waste-side branch pipe having a front end connected to the switching valve and a rear end connected to the waste tank, the method further comprising connecting the connection pipe to the waste-side branch pipe by controlling the switching valve after sensing the presence of the organic impurities.

15. The method of claim 14, further comprising:
separating the connection pipe from the waste-side branch pipe; and
connecting the connection pipe to the buffer-side branch pipe, by controlling the switching valve after sensing the absence of the organic impurities.

16. The method of claim 11, further comprising:
removing the organic impurities in the waste tank; and
transporting the target fluid from which the organic impurities have been removed to the storage tank.

17. (canceled)

18. The method of claim 11, further comprising:
bringing the target fluid into contact with a second SPR sensor connected to the storage tank and the buffer tank; and
sensing, in real time, whether the organic impurities are present in the target fluid by using adsorption and desorption of organic impurities to and from the second SPR sensor.

19. The method of claim 18, wherein the bringing of the target fluid into contact with the second SPR sensor comprises:
circulating the target fluid in the storage tank and the buffer tank; and
bringing the second SPR sensor into contact with the circulating target fluid.

20. A method of sensing organic impurities in semiconductor chemicals by using a surface plasmon resonance (SPR) sensor, the method comprising:
transporting a first target fluid from a first storage tank to a buffer tank;
sensing the presence of organic impurities in the first target fluid by using adsorption and desorption of organic impurities to and from the first SPR sensor;
transporting the first target fluid to a waste tank by adjusting a first switching valve at a rear end of the first SPR sensor;
transporting a second target fluid from a second storage tank to the buffer tank, and
sensing whether organic impurities are present in the second target fluid by using the adsorption and desorption of the organic impurities to and from the second SPR sensor.

21. The method of claim 20, wherein the transporting of the first target fluid to the waste tank and the transporting of the second target fluid to the buffer tank overlap in a time-based manner.

22. The method of claim 20, wherein the organic impurities comprise aromatic compounds.

23-45. (canceled)
